(19) United States
(12) Patent Application Publication
(10) Pub. No.: US 2026/0172530 A1
(43) Pub. Date: Jun. 18, 2026

(54) METHOD AND APPARATUS FOR MONITORING AN INTERIOR OF A CARGO COMPARTMENT

(71) Applicants: HYUNDAI MOTOR COMPANY, Seoul (KR); KIA CORPORATION, Seoul (KR)

(72) Inventors: Hyoeun Jung, Hwaseong-si (KR); Hoongi Lee, Hwaseong-si (KR); Gwangseob Kim, Hwaseong-si (KR); Chan Seok Choi, Hwaseong-si (KR)

(73) Assignees: HYUNDAI MOTOR COMPANY, Seoul (KR); KIA CORPORATION, Seoul (KR)

(21) Appl. No.: 19/400,356

(22) Filed: Nov. 25, 2025

(30) Foreign Application Priority Data
Dec. 13, 2024 (KR) 10-2024-0185615

(51) Int. Cl. H04N 7/18; B60K 35/10; B60K 35/28; B60R 25/30; B60R 25/31

(52) U.S. Cl. CPC H04N 7/185; B60K 35/10; B60K 35/28; B60R 25/305; B60R 25/31; B60K 2360/21

(57) ABSTRACT

A method for monitoring an interior of a cargo compartment, performed by a computing device including a processor and a memory implemented in a vehicle, the method including detecting, by the processor, a motion from a motion detecting sensor installed in an interior of the cargo compartment, and generating, by the processor, different notifications based on the motion being detected based on a smart key existing within the interior of the cargo compartment, the door of the cargo compartment being closed, and the vehicle being started. The method further includes, providing, by the processor, the generated notification to an in-vehicle display device or a user terminal, and providing, by the processor, a user interface enabling a user to input a work history to the in-vehicle display device or the user terminal, based on the motion.

### CROSS-REFERENCE TO RELATED APPLICATION

This application claims priority to and the benefit of Korean Patent Application No. 10-2024-0185615 filed with the Korean Intellectual Property Office on Dec. 13, 2024, the entire contents of which are incorporated herein by reference.

### BACKGROUND

### (a) Technical Field

The present disclosure relates to a method and apparatus for monitoring an interior of a cargo compartment.

### (b) Description of the Related Art

Although monitoring of the interior of the driver's seat in a purpose-built vehicle (PBV) cargo and refrigerated vehicles and provision of services based on the monitoring are provided, services that automatically monitor and manage the interior of cargo compartment are not sufficiently provided. If the internal condition of the cargo compartment can be identified in real time, the possibility or likelihood of problems such as theft, damage, or deterioration of the cargo can be reduced and logistics management can be performed more conveniently. Therefore, a system that can monitor the interior of the cargo compartment and manage the status based on the data is required.

### SUMMARY

The present disclosure attempts to provide a method and apparatus for monitoring an interior of a cargo compartment capable of preventing theft and improving user safety by monitoring an interior of a cargo compartment. The method and apparatus may further be capable of securing or providing convenience in logistics management by managing the work history or identifying object location in the cargo compartment.

A method for monitoring an interior of a cargo compartment, which is performed by a computing device including a processor and a memory implemented in a vehicle, may include: detecting, by the processor, a motion from a motion detecting sensor installed in an interior of the cargo compartment; generating, by the processor, a different notification based on the motion based on a smart key existing within the interior of the cargo compartment, the door of the cargo compartment being closed, and the vehicle being started; providing, by the processor, the generated notification to an in-vehicle display device or a user terminal; and providing, by the processor, a user interface enabling a user to input a work history to the in-vehicle display device or the user terminal, based on the motion.

The generating the notification may include generating, by the processor, a first notification indicating that an unidentified motion occurred within the interior of the cargo compartment, based on it being determined that the smart key does not exist within the interior of the cargo compartment, and the door of the cargo compartment not being closed. The method may further include providing, by the processor, an image captured by a monitoring camera installed in an interior of the cargo compartment to the in-vehicle display device or the user terminal, and recording, by the processor, the image according to a user's selection.

The generating the notification may include generating, by the processor, a second notification indicating that there is a risk of a worker being trapped inside the cargo compartment, based on it being determined that the smart key does not exist within the interior of the cargo compartment, and the door of the cargo compartment being closed, where the method may further include recording, by the processor, an image captured by a monitoring camera installed in an interior of the cargo compartment.

The generating the notification may include generating, by the processor, a third notification indicating that the vehicle is possibly in a situation of departing with a worker inside the cargo compartment, based on it being determined that the vehicle has started.

The providing the user interface may enable a user to input the work history and may include providing, by the processor, a user interface for a work duration, an entire number of times for the work, an average work time, and work details.

The method may further include providing, by the processor, a default value calculated based on a number of times of the door of the cargo compartment opening and closing, with respect to the entire number of times for the work and the average work time.

The motion detecting sensor may include a plurality of ultrasonic wave sensors. The method may further include detecting, by the processor, whether an object exists within a first detection range using a first ultrasonic wave sensor among the plurality of ultrasonic wave sensors having the first detection range, detecting, by the processor, whether an object exists within a second detection range using a second ultrasonic wave sensor among the plurality of ultrasonic wave sensors having the second detection range different from the first detection range, and providing, by the processor, a loaded status of the interior of the cargo compartment to the in-vehicle display device or the user terminal, based on it being detected that the object exists within the first detection range, and that the object does not exist within the second detection range.

The method may further include detecting, by the processor, a distance to the object within the first detection range using the first ultrasonic wave sensor, determining, by the processor, that the motion has not been detected in the first detection range, based on it being detected that there is not a change in the distance to the object within the first detection range for a predetermined period of time, and determining, by the processor, that the motion is detected in the first detection range, based on it being detected that there is a change in the distance to the object within the first detection range during the predetermined period of time.

The method may further include providing, by the processor, a movement trajectory of the object within the interior of the cargo compartment to the in-vehicle display device or the user terminal, based on a detection result of the motion in the first detection range.

The interior of the cargo compartment may be divided into a plurality of sections linked with information of destinations to which respective items are to be delivered. The method may further include generating, by the processor, a notification with respect to a section corresponding to a destination among the plurality of sections through the in-vehicle display device, the user terminal or a light emitting device installed in an interior of the cargo compartment, based on the vehicle arriving at the destination.

An apparatus implemented in a vehicle for monitoring an interior of a cargo compartment may include one or more non-transitory computer-readable media including an instruction, and one or more processors configured to perform an operation by executing the instruction. The operation may include: detecting a motion from a motion detecting sensor installed in an interior of the cargo compartment; generating a different notification based on a smart key existing within the interior of the cargo compartment, the door of the cargo compartment being closed, and the vehicle being started, based on the motion being detected; providing the notification to an in-vehicle display device or a user terminal; and providing a user interface enabling a user to input a work history to the in-vehicle display device or the user terminal, based on the motion.

The generating the notification may include generating a first notification indicating that an unidentified motion occurred within the interior of the cargo compartment, based on it being determined that the smart key does not exist within the interior of the cargo compartment, and the door of the cargo compartment not being closed. The operation may further include providing an image captured by a monitoring camera installed in an interior of the cargo compartment to the in-vehicle display device or the user terminal, and recording the image according to a user's selection.

The generating the notification may include generating a second notification indicating that there is a risk of a worker being trapped inside the cargo compartment, based on it being determined that the smart key does not exist within the interior of the cargo compartment, and the door of the cargo compartment being closed, and the operation may further include recording an image captured by a monitoring camera installed in an interior of the cargo compartment.

The generating the notification may include generating a third notification indicating that the vehicle is possibly in a situation of departing with a worker inside the cargo compartment, based on it being determined that the vehicle has started.

The providing the user interface enabling a user to input the work history may include providing a user interface for a work duration, an entire number of times for the work, an average work time, and work details.

The motion detecting sensor may include a plurality of ultrasonic wave sensors. The operation may further include detecting whether an object exists within a first detection range using a first ultrasonic wave sensor among the plurality of ultrasonic wave sensors having the first detection range, detecting whether an object exists within a second detection range by using a second ultrasonic wave sensor among the plurality of ultrasonic wave sensors having the second detection range different from the first detection range and providing a loaded status of the interior of the cargo compartment to the in-vehicle display device or the user terminal, based on it being detected that the object exists within the first detection range, and that the object does not exist within the second detection range.

The operation may further include detecting a distance to the object within the first detection range using the first ultrasonic wave sensor, determining that the motion has not been detected in the first detection range, based on it being detected that there is not a change in the distance to the object within the first detection range during a predetermined period of time, and determining that the motion is detected in the first detection range, based on it being detected that there is a change in the distance to the object within the first detection range during the predetermined period of time.

The operation may further include providing a movement trajectory of the object within the interior of the cargo compartment to the in-vehicle display device or the user terminal, based on a detection result of the motion in the first detection range.

The interior of the cargo compartment may be divided into a plurality of sections linked with information of destinations to which respective items are to be delivered. The operation may further include generating a notification with respect to a section corresponding to a destination among the plurality of sections through the in-vehicle display device, the user terminal or a light emitting device installed in an interior of the cargo compartment, based on the vehicle arriving at the destination.

One or more non-transitory computer-readable media comprising an instruction executable by a computing device is provided, where the instruction may cause a computing device to perform the operation when executed by one or more processors of the computing device. The operation may include detecting a motion from a motion detecting sensor installed in an interior of a cargo compartment, generating a different notification based on motion being detected based on a smart key existing within the interior of the cargo compartment, the door of the cargo compartment being closed, and the vehicle being started providing the notification to an in-vehicle display device or a user terminal, and providing a user interface enabling a user to input a work history to the in-vehicle display device or the user terminal, based on the motion.

### BRIEF DESCRIPTION OF THE DRAWINGS

FIG. 1 illustrates an apparatus for monitoring an interior of a cargo compartment according to an embodiment of the present disclosure.

FIG. 2 illustrates an implementation example of an apparatus and method for monitoring an interior of a cargo compartment according to an embodiment of the present disclosure.

FIG. 3 illustrates an implementation example of an apparatus and method for monitoring an interior of a cargo compartment according to an embodiment of the present disclosure.

FIG. 4 illustrates an implementation example of an apparatus and method for monitoring an interior of a cargo compartment according to an embodiment of the present disclosure.

FIG. 5 illustrates an implementation example of an apparatus and method for monitoring an interior of a cargo compartment according to an embodiment of the present disclosure.

FIG. 6 illustrates a method for monitoring an interior of a cargo compartment according to an embodiment of the present disclosure.

FIG. 7 illustrates a method for monitoring an interior of a cargo compartment according to an embodiment of the present disclosure.

FIG. 8 illustrates a computing device according to an embodiment of the present disclosure.

### DETAILED DESCRIPTION

The present disclosure is described more fully hereinafter with reference to the accompanying drawings, in which embodiments of the disclosure are shown. As those of ordinary skill in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like have been used only to describe various constituent elements, and are not to be interpreted as limiting these constituent elements. The terms are only used to differentiate one constituent element from other constituent elements.

In addition, terms such as “ . . . part,” “ . . . portion,” “ . . . er/or,” or “module” disclosed in the present specification may mean a unit that may process at least one function or operation described in this specification, and this may be implemented by hardware, software, or a combination thereof. Additionally, at least some of the configurations or functions of a method and apparatus for monitoring an interior of a cargo compartment according to the embodiments described below may be implemented as a program or software, and the program or software may be stored in a non-transitory computer-readable medium. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

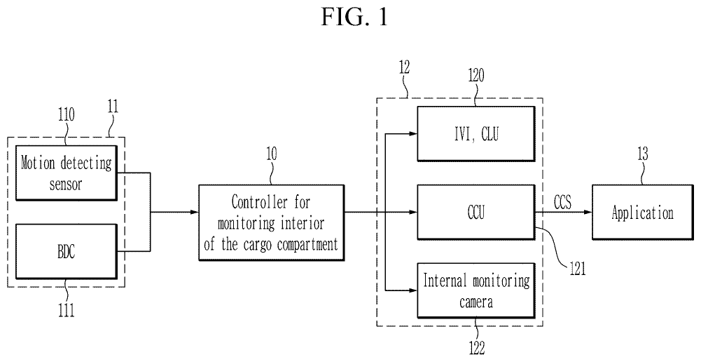

FIG. 1 is a drawing for explaining an apparatus for monitoring an interior of a cargo compartment according to an embodiment.

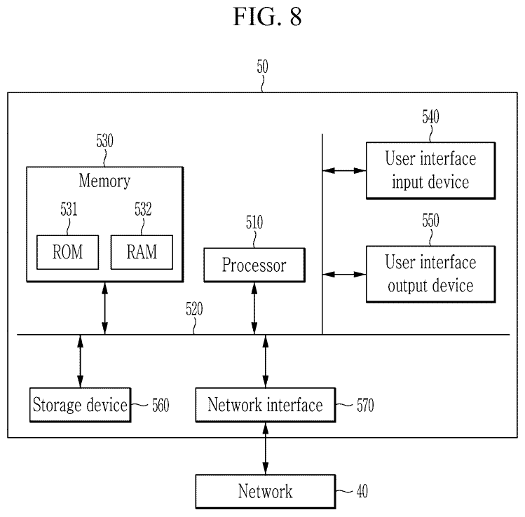

As shown in FIG. 1, an apparatus for monitoring an interior of a cargo compartment according to an embodiment may be implemented as a controller 10 for monitoring an interior of a cargo compartment. The controller 10 for monitoring an interior of a cargo compartment may be implemented as a computing device including a processor and memory. For example, a connection device for the vehicle and an external device may be implemented as a computing device 50, described hereinafter in connection with FIG. 8. Here, the computing device 50 may be implemented in a vehicle 1, for example, as a controller mounted on the vehicle 1. In this case, the processor may correspond to a processor 510 of the computing device 50, and the memory may correspond to a memory 520 of the computing device 50. Alternatively, in some embodiments, the controller 10 for monitoring an interior of a cargo compartment may include one or more non-transitory computer-readable media including an instruction or set of instructions and one or more processors configured to perform an operation by executing the instruction(s). The operation may include configurations, functions, steps, or the like described in this specification with respect to a method and apparatus for monitoring an interior of a cargo compartment according to the embodiments described herein. In this specification, the term “module” is used in order to logically differentiate these operations performed by a method and apparatus for monitoring an interior of a cargo compartment according to the embodiments. A body domain controller (BDC) 111, an in-vehicle infotainment (IVI) and cluster (CLU) 120, and a central communication unit (CCU) 121, illustrated in the drawings, may also be implemented as the computing device 50.

The controller 10 for monitoring an interior of a cargo compartment may be implemented within the vehicle 1. The controller 10 for monitoring an interior of a cargo compartment may exchange data with another vehicle controller and sensor implemented together within the vehicle 1 through an internal network. In some embodiments, the internal network may include a controller area network (CAN), a local interconnect network (LIN), and an automotive ethernet, or the like. For example, another vehicle controller and sensor implemented together with the controller 10 for monitoring an interior of a cargo compartment may include, a motion detecting sensor 110 and the BDC 111, which can be classified as a display unit 11, and an IVI and CLU 120, the CCU 121, and an internal monitoring camera 122, which can be classified as a display warning unit 12. In one example, the IVI and CLU 120 may provide notifications to a driver, and the CCU 121 and connected car service (CCS) may provide notification to the driver by being linked with an application 13. The BDC 111 may be used in order to detect a smart key. Hereinafter, the controller 10 for monitoring an interior of a cargo compartment may be referred to as a cargo monitoring an apparatus 10.

The apparatus 10 for monitoring an interior of a cargo compartment may detect a motion from the motion detecting sensor 110 installed inside the cargo compartment. The motion detecting sensor 110 may be mounted in order to detect a motion in the interior of the cargo compartment, and may include, for example, an Infrared (IR) camera that can detect motion by detecting a shape even in a dark environment, a vehicle interior detection radar specialized in motion detection, and an (e.g., inexpensive) ultrasonic wave sensor mounted on an upper end or side surface of the cargo and installed with a logic for monitoring motion.

When motion or movement (e.g., of an item or object in the interior of the cargo compartment) is detected by the motion detecting sensor 110, the apparatus 10 for monitoring an interior of a cargo compartment may generate different notifications depending on whether the smart key exists within the interior of the cargo compartment, whether the door of the cargo compartment is closed, and whether the vehicle is started. The apparatus 10 for monitoring an interior of a cargo compartment may provide the notification to an in-vehicle display device, and may be provided in or via the application 13 executed in a user terminal.

In more detail, the apparatus 10 for monitoring an interior of a cargo compartment may generate a first notification representing that unidentified motion occurred within the interior of the cargo compartment, when it is determined that the smart key does not exist within the interior of the cargo compartment, and the door of the cargo compartment is not closed. In some embodiments, the apparatus 10 for monitoring an interior of a cargo compartment may provide a photograph or image captured by the monitoring camera installed inside the cargo compartment to the in-vehicle display device or the user terminal. In some embodiments, the apparatus 10 for monitoring an interior of a cargo compartment may record the photograph or image according to a user's selection. For example, while a text such as “Motion occurred inside the cargo compartment. Please check the interior of the cargo compartment.” as the first notification is displayed on the IVI 120, a “monitoring” button may be popped up simultaneously, or the pop-up of the text and button may be implemented through the application 13 based on CCS. When the user presses the “monitoring” button, the user can directly check (e.g., view) the image photographed or captured by the monitoring camera installed inside the cargo compartment. Of course, the first notification may also be implemented as a voice warning. Accordingly, a theft preventing notification of the interior of the cargo compartment may be implemented, and the image of the interior of the cargo compartment may be provided.

When it is determined that the smart key does not exist within the interior of the cargo compartment, and the door of the cargo compartment is closed, the apparatus 10 for monitoring an interior of a cargo compartment may generate a second notification representing that there is a risk of a worker being trapped inside the cargo compartment. In some embodiments, the apparatus 10 for monitoring an interior of a cargo compartment may record the photograph or image of the monitoring camera installed inside the cargo compartment. For example, while a text such as “A person is detected inside the cargo compartment. Please check the interior of the cargo compartment.” as the second notification is displayed on the IVI 120, a “monitoring” or “record” button may be popped up simultaneously, or the pop-up of the text and button may be implemented through the application 13 based on CCS. When the user presses the “monitoring” button, the user can directly check (e.g., view) the image photographed by the monitoring camera installed inside the cargo compartment, and when pressing the “record” button, the photograph(s) or image(s) may be recorded. Of course, the second notification may also be implemented as a voice warning. Accordingly, situations where a worker is locked up inside the cargo compartment can be prevented, and the image of the interior of the cargo compartment may be provided.

The apparatus 10 for monitoring an interior of a cargo compartment may generate a third notification representing that the vehicle is possibly in a situation of departing while a worker is inside the cargo compartment, when it is determined that the vehicle has started. For example, a text such as “The vehicle has started and there has been motion inside the cargo compartment. Please check the interior of the cargo compartment.” as the third notification is displayed on the IVI 120, or the text may be displayed through the application 13 based on CCS. Of course, the third notification may also be implemented as a voice warning. Accordingly, the situation in which the vehicle starts while the worker is working may be prevented.

In response to a motion detected by the motion detecting sensor 110, the apparatus 10 for monitoring an interior of a cargo compartment may provide a user interface enabling inputting (e.g., enabling a user to input) a work history into the in-vehicle display device or the user terminal. Conventionally, the driver has managed delivery history manually, which resulted in inconveniences such as missing delivery information or having to manually enter it. As the work history management of the vehicle can be automated by the apparatus 10 for monitoring an interior of a cargo compartment, the user convenience and the reliability of work information can be improved. In addition, when an item theft or a delivery failure has occurred, the stored history may be promptly checked, and automatic management of the cargo work history may be enabled through automatic detection during working inside the vehicle and history storing function, thereby providing convenience to logistics delivery business managers, logistics individual business owners, and delivery drivers.

In more detail, for management of work history, the apparatus 10 for monitoring an interior of a cargo compartment may provide a user interface for a work duration, an entire number of times for the work is performed inside the cargo compartment (e.g., a number of times items have been loaded into or unloaded from the cargo compartment), an average work time, and work details. In some embodiments, regarding the entire number of times for the work and average work time, a default value calculated based on the number of times of door opening and door closing of the cargo compartment may be provided. When a motion of a person is detected by the motion detecting sensor 110 in the interior of the cargo compartment, a user interface like the above may be displayed, through which work history can be added.

The motion detecting sensor 110 may include a plurality of ultrasonic wave sensors. The apparatus 10 for monitoring an interior of a cargo compartment may detect whether an object exists within the first detection range by using a first ultrasonic wave sensor having a first detection range, among the plurality of ultrasonic wave sensors. In addition, the apparatus 10 for monitoring an interior of a cargo compartment may detect whether an object exists within the second detection range by using a second ultrasonic wave sensor having a second detection range different from the first detection range, among the plurality of ultrasonic wave sensors. When it is detected that an object exists within the first detection range, and that an object does not exist within the second detection range, the apparatus 10 for monitoring an interior of a cargo compartment may provide a loaded status of the interior of the cargo compartment to the in-vehicle display device or the user terminal. Accordingly, locations of objects within the cargo compartment may be identified.

In some embodiments, the apparatus 10 for monitoring an interior of a cargo compartment may detect a distance to an object within the first detection range by using the first ultrasonic wave sensor. When it is detected that there is not a change in the distance to the object within the first detection range for a predetermined time, the apparatus 10 for monitoring an interior of a cargo compartment may determine that a motion has not been detected in the first detection range. Alternatively, when it is detected that there is a change in the distance to the object within the first detection range for the predetermined time, the apparatus 10 for monitoring an interior of a cargo compartment may determine that the motion is detected in the first detection range.

In some embodiments, the apparatus 10 for monitoring an interior of a cargo compartment may provide a movement trajectory of the item within the interior of the cargo compartment to the in-vehicle display device or the user terminal, based on a detection result of the motion in the first detection range.

The apparatus 10 for monitoring an interior of a cargo compartment may implement a service of providing object locations in the interior of the cargo compartment through the application 13, based on functions like the above. Specifically, the interior of the cargo compartment may be divided into a plurality of sections linked with information of destinations to which respective items are to be delivered, and when the vehicle has arrived at the destination, the apparatus 10 for monitoring an interior of a cargo compartment may generate a notification with respect to a section corresponding to destination among the plurality of sections through the in-vehicle display device, the user terminal, or a light emitting device installed inside the cargo compartment.

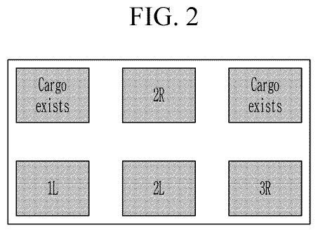

FIG. 2 is a drawing for explaining an implementation example of an apparatus and method for monitoring an interior of a cargo compartment according to an embodiment.

Referring to FIG. 2, the apparatus 10 for monitoring an interior of a cargo compartment may detect the distance to the object within the first detection range by using the first ultrasonic wave sensor, and when it is detected that there is not a change in the distance to the object within the first detection range for the predetermined time, it may be determined that a motion has not been detected in the first detection range. Alternatively, when it is detected that there is a change in the distance to the object within the first detection range for the predetermined time, the apparatus 10 for monitoring an interior of a cargo compartment may determine that the motion is detected in the first detection range. Accordingly, a region with cargo and a region without cargo may be distinguished inside the cargo compartment, and visual information on the cargo status may be displayed on the IVI 120, as shown in the drawings. As illustrated in FIG. 2, visual information may be displayed on the IVI 120, including regions in which cargo may be placed, indicated by reference numerals 1L, 1R, 2L, and 3R, and regions in which cargos have been placed, indicated by the text “Cargo exists.”

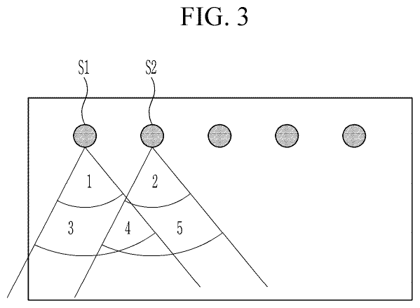

FIG. 3 is a drawing for explaining an implementation example of an apparatus and method for monitoring an interior of a cargo compartment according to an embodiment.

Referring to FIG. 3, motion trajectory determination and monitoring utilizing the ultrasonic wave sensor(s) may be performed by mounting the ultrasonic wave sensors S1 and S2 on the upper end and side surface of the cargo compartment. The ultrasonic wave sensor may divide the interior of the cargo compartment into multiple sections, depending on the regions to detect (e.g., for which detection is provided), and a master sensor (e.g., controller) may track a path along which the object moves within the detection region. For example, if an object moves to regions 1, 4, and 5 over time, the object can be determined to be moving, and if it continues to be detected in a specific region, the object can be recognized to be stationary. This allows for effective monitoring of the real-time location and movement path of objects.

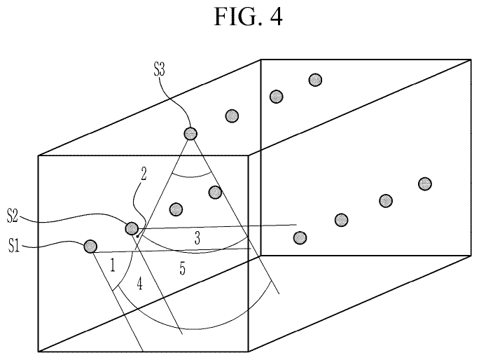

FIG. 4 is a drawing for explaining an implementation example of an apparatus and method for monitoring an interior of a cargo compartment according to an embodiment.

Referring to FIG. 4, the more ultrasonic wave sensors are installed, the greater the accuracy of detection and movement path tracking inside the cargo compartment. For example, by dividing the detection region into regions 1-5, the precise location of an object can be identified, and detailed judgment of the trajectory when the object moves can be made. Additionally, even if some sensors are obscured by the items to be delivered, other sensors can compensate for this and continue to track the movement path of an item or object. In particular, by simultaneously mounting ultrasonic sensors on the top and sides of the cargo compartment, the movement path in three-dimensional space can be estimated, enabling more precise tracking. For example, a first region 1 may be a region where a first side surface sensor S1 detects 30 cm or less, and a second region 2 may be a region where a second side sensor S2 detects 30 cm or less. A third region 3 may be a region where the second side sensor S2 detects 30 cm or less and a top sensor S3 detects 50 cm or less. A fourth region 4 may be a region where the first side sensor S1 detects 50 cm or less and the top sensor S3 detects 60 cm or less. A fifth region 5 can also be defined in a similar way. When multiple sensors operate simultaneously at different heights and locations, the movement and stationary state within a three-dimensional space can be accurately determined.

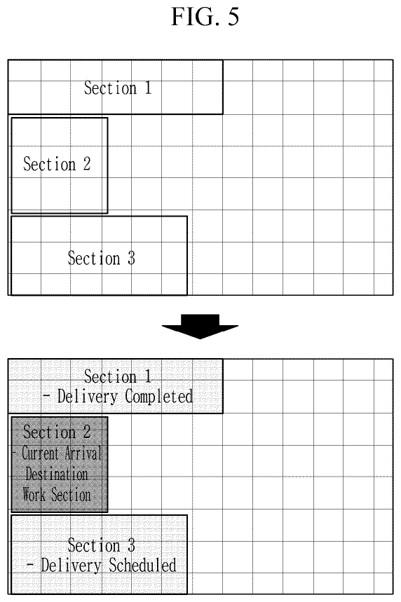

FIG. 5 is a drawing for explaining an implementation example of an apparatus and method for monitoring an interior of a cargo compartment according to an embodiment.

Referring to FIG. 5, the object location determination service within the cargo compartment may be implemented, locations of items loaded inside the cargo compartment can be detected by utilizing the motion detecting sensor, and this may be visually displayed on the screen of the IVI 120 or an application 130. This can improve the convenience of delivery work by linking the delivery location and the loading location of items to increase the efficiency of logistics delivery. Since the loaded status of the objects and space utilization information can be provided to the user through the IVI 120 or the application 130, the loading capacity of the cargo compartment can be determined, and the progress of the delivery work may be checked during the logistics delivery, the work convenience of the delivery driver can be increased. Additionally, as a PBV-specific function, it is possible to use space according to its intended use by indicating whether respective sections are occupied. Additionally, delivery drivers can further improve work efficiency by linking pre-selected regions with navigation destinations.

For example, the user or the delivery driver may distinguish regions by visualizing the interior of the cargo compartment in a grid structure and selecting specific sections, and when cameras are mounted on the top and side surfaces simultaneously, a three-dimensional grid can be utilized to create spatial blocks even more precisely. The space sections divided as such can be linked to destinations, respectively, so that, for example, Section 1 can be automatically linked to Destination 1, Section 2 to Destination 3, and the like. Afterwards, the destination and address are linked, and when the delivery driver selects a specific destination, the navigation can automatically guide the route. For unloading work upon arrival of the vehicle, a corresponding section is activated on the IVI 120 screen to visually indicate the items to work with, blocked section regions may be represented through LEDs (on the floor) or lasers (on the ceiling) additionally installed inside the cargo compartment, and the section to work with may be highlighted in red, thereby maximizing the convenience and accuracy of the work.

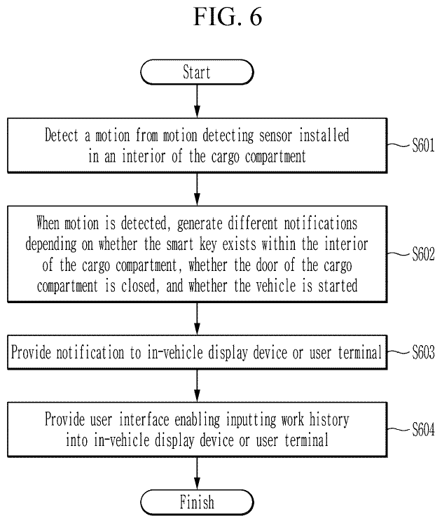

FIG. 6 is a drawing for explaining a method for monitoring an interior of a cargo compartment according to an embodiment.

Referring to FIG. 6, a method for monitoring an interior of a cargo compartment according to an embodiment may perform a step S601 of detecting a motion from or via the motion detecting sensor installed inside the cargo compartment, a step S602 of generating a different notification when motion is detected depending or based on whether the smart key exists within the interior of the cargo compartment, whether the door of the cargo compartment is closed, and whether the vehicle is started, a step S603 of providing the notification to the in-vehicle display device or the user terminal, and a step S604 of providing a user interface enabling input of a work history into the in-vehicle display device or the user terminal.

For more detailed information about the above method, reference can be made to the description of the embodiments described in this specification. Accordingly, a redundant description thereof is omitted here.

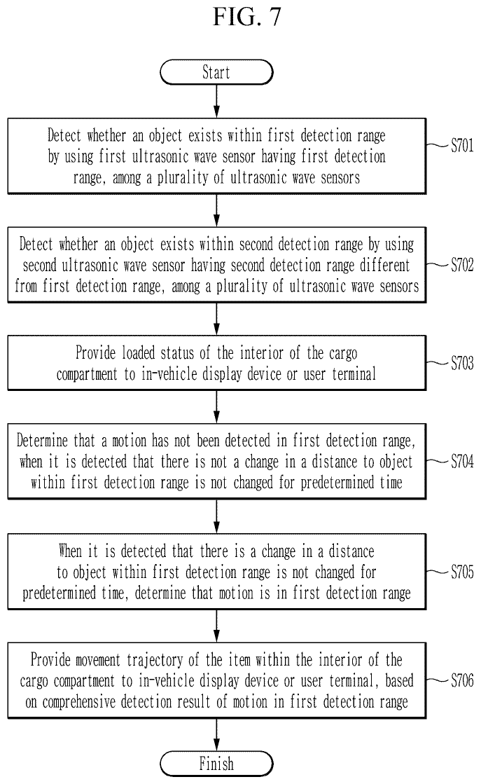

FIG. 7 is a drawing for explaining a method for monitoring an interior of a cargo compartment according to an embodiment.

Referring to FIG. 7, a method for monitoring an interior of a cargo compartment according to an embodiment may perform a step S701 of detecting whether an object exists within the first detection range using the first ultrasonic wave sensor having the first detection range among the plurality of ultrasonic wave sensors and a step S702 of detecting whether an object exists within the second detection range by using the second ultrasonic wave sensor having the second detection range different from the first detection range among the plurality of ultrasonic wave sensors. The method may further include a step S703 of providing the loaded status of the interior of the cargo compartment to the in-vehicle display device or the user terminal, a step S704 of determining that motion has not been detected in the first detection range when it is detected that there is not a change in the distance to the object within the first detection range for the predetermined time, a step S705 of determining that the motion is detected in the first detection range when it is detected that there is a change in the distance to the object within the first detection range for the predetermined time, and a step S706 of providing the movement trajectory of the object within the interior of the cargo compartment to the in-vehicle display device or the user terminal, based on the comprehensive detection result of the motion in the first detection range.

For more detailed information about the above method, reference can be made to the description of the embodiments described in this specification. Accordingly, a redundant description thereof is omitted here.

FIG. 8 is a drawing for explaining a computing device according to an embodiment.

Referring to FIG. 8, a method and apparatus for monitoring an interior of a cargo compartment according to the embodiments may be implemented using the computing device 50. The computing device 50 may be implemented as various types of electronic devices, servers or similar devices, and its function may be implemented through a combination of software and hardware.

The computing device 50 may include at least one of a processor 510, a memory 530, a user interface input device 540, a user interface output device 550 and a storage device 560 that communicate with each other through a bus 520. The computing device 50 may include a network interface 570 electrically connected to a network 40. The network interface 570 may send or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may be configured to implement the various functions and methods described above with reference to FIGS. 1-7.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means, for example, a peripheral component interconnect express (PCIe) interface for high-speed data transmission or a memory controller.

In some embodiments, at least some of the components or functions of a according to the embodiments may be implemented as a program or software executed on the computing device 50, and the program or software may be stored on a (e.g. non-transitory) computer-readable recording medium or storage medium. Specifically, according to an embodiment, a computer-readable recording medium or storage medium may record a program for executing steps included in an implementation of a method and apparatus for monitoring an interior of a cargo compartment according to embodiments, on a computer including the processor 510 executing a program or instructions stored in the memory 530 or the storage device 560.

In some embodiments, at least some configuration or function of a method and apparatus for monitoring an interior of a cargo compartment according to embodiments may be implemented by using hardware or circuitry of the computing device 50. In some embodiments, at least some configuration or function of the method and apparatus may alternatively or additionally be implemented by using separate hardware or circuitry that may be electrically connected to the computing device 50.

In some embodiments, one or more non-transitory computer-readable media including an instruction executable by the computing device 50 may be provided, and the instruction may cause the computing device 50 to perform the operation, when executed by one or more processors of the computing device 50. Here, the operation may include configurations, functions, steps, or the like described in this specification in connection with a method and apparatus for monitoring an interior of a cargo compartment according to embodiments.

According to the embodiments, the ability to monitor the interior of a cargo vehicle and provide an alarm to the driver can contribute to user safety by preventing theft, detecting and providing an alarm when a worker is trapped inside a refrigerated vehicle, or providing a warning alarm when the vehicle starts during operation. In addition, convenience is increased by automatically saving and managing logistics delivery history, and work history enables rapid response in the case of delivery abnormalities. Meanwhile, by installing an ultrasonic sensor on the top or side surface of the cargo compartment to monitor the movement and trajectory of the object, movement of the object can be effectively detected at a low cost, and the efficiency of logistics delivery work can be increased by providing a service to determine the location of the object within the cargo compartment.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A method for monitoring an interior of a cargo compartment, the method being performed by a computing device comprising a processor and a memory implemented in a vehicle, the method comprising:
detecting, by the processor, a motion from a motion detecting sensor installed in the interior of the cargo compartment;
generating, by the processor based on the motion being detected, different notifications based on a smart key existing within the interior of the cargo compartment, a door of the cargo compartment being closed, and the vehicle being started;
providing, by the processor, the generated notifications to an in-vehicle display device or a user terminal; and
providing, by the processor, a user interface enabling a user to input a work history to the in-vehicle display device or the user terminal, based on the motion.

2. The method of claim 1, wherein generating the different notifications comprises generating, by the processor, a first notification indicating that an unidentified motion occurred within the interior of the cargo compartment, based on a determination that the smart key does not exist within the interior of the cargo compartment, and the door of the cargo compartment not being closed,
wherein the method further comprises:
providing, by the processor, an image captured by a monitoring camera installed in the interior of the cargo compartment to the in-vehicle display device or the user terminal; and
recording, by the processor, the image according to a user's selection.

3. The method of claim 1, wherein generating the different notifications comprises generating, by the processor, a second notification indicating that there is a risk of a worker being trapped inside the cargo compartment, based on a determination that the smart key does not exist within the interior of the cargo compartment, and the door of the cargo compartment being closed,
wherein the method further comprises recording, by the processor, an image captured by a monitoring camera installed in the interior of the cargo compartment.

4. The method of claim 1, wherein generating the different notifications comprises generating, by the processor, a third notification indicating that the vehicle is possibly in a situation of departing with a worker inside the cargo compartment, based on a determination that the vehicle has started.

5. The method of claim 1, wherein providing the user interface enabling the user to input the work history comprises providing, by the processor, the user interface for a work duration, an entire number of times for the work, an average work time, and work details.

6. The method of claim 5, further comprising providing, by the processor, a default value calculated based on a number of times of the door of the cargo compartment opening and closing, with respect to the entire number of times for the work and the average work time.

7. The method of claim 1, wherein the motion detecting sensor comprises a plurality of ultrasonic wave sensors, and
wherein the method further comprises:
detecting, by the processor, whether an object exists within a first detection range using a first ultrasonic wave sensor among the plurality of ultrasonic waver sensors having the first detection range;
detecting, by the processor, whether an object exists within a second detection range using a second ultrasonic wave sensor among the plurality of ultrasonic wave sensors having the second detection range different from the first detection range; and
providing, by the processor, a loaded status of the interior of the cargo compartment to the in-vehicle display device or the user terminal, based on it being detected that the object exists within the first detection range, and that the object does not exist within the second detection range.

8. The method of claim 7, further comprising:
detecting, by the processor, a distance to the object within the first detection range using the first ultrasonic wave sensor;
determining, by the processor, that the motion has not been detected in the first detection range, based on it being detected that there is not a change in the distance to the object within the first detection range during a predetermined period of time; and
determining, by the processor, that the motion is detected in the first detection range, based on it being detected that there is a change in the distance to the object within the first detection range during the predetermined period of time.

9. The method of claim 8, further comprising providing, by the processor, a movement trajectory of the object within the interior of the cargo compartment to the in-vehicle display device or the user terminal, based on a detection result of the motion in the first detection range.

10. The method of claim 1, wherein the interior of the cargo compartment is divided into a plurality of sections linked with information of destinations to which respective items are to be delivered,
wherein the method further comprises generating, by the processor, a notification with respect to a section corresponding to a destination among the plurality of sections through the in-vehicle display device, the user terminal or a light emitting device installed in an interior of the cargo compartment, based on the vehicle arriving at the destination.

11. An apparatus implemented in a vehicle for monitoring an interior of a cargo compartment, the apparatus comprising:
one or more non-transitory computer-readable media comprising an instruction; and
one or more processors configured to perform an operation by executing the instruction,
wherein the operation comprises:
detecting a motion from a motion detecting sensor installed in the interior of the cargo compartment;
generating, based on the motion being detected, different notifications based on a smart key existing within the interior of the cargo compartment, a door of the cargo compartment being closed, and the vehicle being started;
providing the generated notifications to an in-vehicle display device or a user terminal; and
providing a user interface enabling a user to input a work history to the in-vehicle display device or the user terminal, based on the motion.

12. The apparatus of claim 11, wherein generating the different notifications comprises generating a first notification indicating that an unidentified motion occurred within the interior of the cargo compartment, based on a determination that the smart key does not exist within the interior of the cargo compartment, and the door of the cargo compartment not being closed, and
the operation further comprises:
providing an image captured by a monitoring camera installed in an interior of the cargo compartment to the in-vehicle display device or the user terminal; and
recording the image according to a user's selection.

13. The apparatus of claim 11, wherein generating the different notifications comprises generating a second notification indicating that there is a risk of a worker being trapped inside the cargo compartment, based on it being determined that the smart key does not exist within the interior of the cargo compartment, and the door of the cargo compartment being closed, and
wherein the operation further comprises recording an image captured by a monitoring camera installed in the interior of the cargo compartment.

14. The apparatus of claim 11, wherein generating the different notifications comprises generating a third notification indicating that the vehicle is possibly in a situation of departing with a worker inside the cargo compartment, based on it being determined that the vehicle has started.

15. The apparatus of claim 11, wherein providing the user interface enabling the user to input the work history comprises providing a user interface for a work duration, an entire number of times for the work, an average work time, and work details.

16. The apparatus of claim 11, wherein the motion detecting sensor comprises a plurality of ultrasonic wave sensors, and
wherein the operation further comprises:
detecting whether an object exists within a first detection range using a first ultrasonic wave sensor among the plurality of ultrasonic wave sensors having the first detection range;
detecting whether an object exists within a second detection range using a second ultrasonic wave sensor among the plurality of ultrasonic wave sensors having the second detection range different from the first detection range; and
providing a loaded status of the interior of the cargo compartment to the in-vehicle display device or the user terminal, based on it being detected that the object exists within the first detection range, and that the object does not exist within the second detection range.

17. The apparatus of claim 16, wherein the operation further comprises:
detecting a distance to the object within the first detection range using the first ultrasonic wave sensor;
determining that the motion has not been detected in the first detection range, based on it being detected that there is not a change in the distance to the object within the first detection range during a predetermined period of time; and
determining that the motion is detected in the first detection range, based on it being detected that there is a change in the distance to the object within the first detection range during the predetermined period of time.

18. The apparatus of claim 17, wherein the operation further comprises providing a movement trajectory of the object within the interior of the cargo compartment to the in-vehicle display device or the user terminal, based on a detection result of the motion in the first detection range.

19. The apparatus of claim 11, wherein:
the interior of the cargo compartment is divided into a plurality of sections linked with information of destinations to which respective items are to be delivered; and
the operation further comprises generating a notification with respect to a section corresponding to a destination among the plurality of sections through the in-vehicle display device, the user terminal or a light emitting device installed in an interior of the cargo compartment, based on the vehicle arriving at the destination.

20. One or more non-transitory computer-readable media comprising an instruction executable by a computing device, the instruction causing a computing device to perform an operation when executed by one or more processors of the computing device, wherein the operation comprises:
detecting a motion from a motion detecting sensor installed in an interior of a cargo compartment;
generating, based on motion being detected, different notifications based on a smart key existing within the interior of the cargo compartment, a door of the cargo compartment being closed, and a vehicle being started;
providing the notification to an in-vehicle display device or a user terminal; and
providing a user interface enabling a user to input a work history to the in-vehicle display device or the user terminal, based on the motion.
